(19) United States
(12) Patent Application Publication
(10) Pub. No.: US 2022/0400439 A1
(43) Pub. Date: Dec. 15, 2022

(54) SIDE CHANNEL MECHANISM FOR CONTROLLING DATA FLOWS

(71) Applicant: Verizon Patent and Licensing Inc., Basking Ridge, NJ (US)

(72) Inventors: Donna L. Polehn, Mercer Island, WA (US); Corey J. Christopherson, Bainbridge Island, WA (US)

(21) Appl. No.: 17/342,942

(22) Filed: Jun. 9, 2021

(51) Int. Cl. H04W 52/02; H04W 28/12; H04J 13/00

(52) U.S. Cl. CPC H04W 52/0235; H04W 52/0229; H04W 28/12; H04J 13/0062

(57) ABSTRACT

A method for generating, at a mobile device, a first flow control sequence for demodulating a first wireless channel transmitted by a base station; transitioning, by the user equipment device (UE), to a first power consumption state; monitoring, by the UE while in the first power consumption state, the first wireless channel for a second flow control sequence; detecting, at the UE, that the first flow control sequence matches the second flow control sequence; transitioning, by the UE from the first power consumption state to a second power consumption state, upon detecting that the first flow control sequence matches the second flow control sequence; and receiving, at the UE, a data flow from the base station via a second wireless channel.

### BACKGROUND

Long Term Evolution (LTE) is an existing mobile telecommunications standard for wireless communications. Next Generation wireless networks, such as fifth generation (5G) networks, provide increased capacity and speed. To reduce power consumption and heat dissipation in user equipment devices (UEs) receiving data from LTE and/or 5G networks, discontinuous reception mechanisms can be used at the UE receiving data packets. However, discontinuous reception may introduce latency and/or jitter into packet data received by the UE.

### BRIEF DESCRIPTION OF THE DRAWINGS

FIG. 1 is a diagram illustrating an example wireless communication system consistent with an embodiment;

FIG. 2 is a block diagram showing an example of a user equipment device (UE) and a base station consistent with an embodiment;

FIG. 3 is a block diagram showing an example configuration of components for a UE according to an embodiment;

FIG. 4 is a block diagram illustrating an example configuration of components for a base station according to an embodiment;

FIG. 5 is a diagram showing example message flows between a UE and a base station consistent with an embodiment;

FIG. 6 is a flow chart showing an example process associated with a UE that monitors a side channel for controlling data flows; and

FIG. 7 is a flow chart illustrating an example process associated with a base station that provides a side channel for controlling data flows.

### DETAILED DESCRIPTION OF EXAMPLE EMBODIMENTS

The following detailed description refers to the accompanying drawings. The same reference numbers in different drawings may identify the same or similar elements. The following detailed description does not limit the scope of the invention.

Improvements in modern telecommunication networks have led to increased usage of User Equipment devices (UE), including mobile communication handsets (e.g., smart phones) and/or Internet of things (IoT) devices. This increased usage may present challenges for the design of UEs in terms of, for example, energy storage and/or heat dissipation. For example, the contemporary design constraints of thin form factors can place limits on the size of internal batteries, and thus reduce the energy storage capacity, leading to reduced operating times. Additionally, heat dissipation by active components (e.g., transceivers, processors, batteries, etc.) during both operating times and battery charging periods should be managed as mobile devices may be too small to include traditional fans and/or conventional heat sinks.

One technique for conserving power, increasing battery operating times, and/or reducing generated heat within mobile devices is through a mechanism called discontinuous reception. One type of discontinuous reception (DRX) mechanism may be referred to as “connected-mode DRX” (cDRX). CDRX cycles the power in the radio (e.g., transmitter, receiver, amplifier(s), modulator(s), etc.) on and off based on predetermined timers, effectively lowering the duty-cycle of the mobile device.

However, cycling the power of the mobile device in accordance with cDRX techniques may increase the latency and/or jitter of packets within the data flows received from the base station by the mobile device. Thus, the ultra-low latencies touted by the 5G wireless standards may be difficult to achieve when cDRX cycling approaches are used, because packets will be delayed accommodating the cDRX period when power is being cycled on the mobile device. For example, if cDRX is set to cycle at 50 milliseconds, then if packets arrive at the base station towards the beginning of the cDRX cycle, then latencies cannot be reduced below 50 milliseconds. If by chance packets arrive at the end of the cDRX cycle, then latency can be lower than the 50 millisecond cycle time. In either event, on average, the latency time of data packets will be elevated. Moreover, this latency can be variable, and thus large amounts of jitter may be introduced into the packets comprising data flows as well. Variable latency may be particularly challenging for time-sensitive applications (e.g., games, communications, remote surgery) because such latencies can be difficult to predict and compensate.

An approach for reducing or eliminating the latency and/or jitter associated with cDRX techniques may include establishing a flow control signal that can inform the UE when data packets are being sent by the base station. The flow control signal may inform the UE to wake at a time when data packets are available at the base station for transmission to the UE, rather than buffering packets at the base station to wait for predesignated intervals when the UE is not within a cDRX cycle. The flow control signal may be transmitted on a subchannel having a narrow bandwidth and may be modulated with a high reliability modulation scheme that can be easily demodulated.

In an embodiment, one approach for avoiding the latency due to cDRX cycling may include establishing a subchannel to provide a flow control signaling mechanism. The subchannel, also referred to herein as a “side channel,” may be a narrow band channel which is modulated with a high reliability but easily demodulated scheme, such as, for example, binary phase shift keying (BPSK) and/or Zadoff-Chu encoding. The side channel may be used as a signaling mechanism to wake the radio of the UE from a reduced power consumption state when data packets are available rather than wait for an interval prescribed by cDRX. In an embodiment, the UE may have a designated side channel receiver that is active when the UE is fully operational (e.g., in an “active state”) or in a reduced power consumption state (e.g., in a “sleep” state). This means that the side channel receiver would remain active continuously, but it may only monitor a narrow band portion of the receive spectrum and would only need to demodulate a narrow channel, and thus may require less power to monitor and demodulate. In an embodiment, Zadoff-Chu encoding may provide the basis for a side channel signal since Zadoff-Chu sequences may be decoded quickly and efficiently in hardware. Thus, even if the side channel signaling is sent over a lower band, decoding may not add significantly to the latency. For example, once a Zadoff-Chu pattern is received over the side channel, it may be decoded within nanoseconds. Accordingly, the side channel receiver may be implemented in hardware to reduce power consumption and/or improve the speed at which demodulation of the side channel may occur. Various embodiments may use other types of encoding instead of Zadoff-Chu, such as, for example, other codes that work in a manner similar to Viterbi and/or turbo codes. However, Zadoff-Chu encoding can provide transmission efficiencies with lower bandwidth channels (e.g., side channels as described herein) that other types of encoding techniques cannot. Moreover, Zadoff-Chu sequences may be used in other aspects associated with the long term evolution (LTE) and Fifth Generation (5G) wireless standards, and thus the properties and efficient generation of Zadoff-Chu sequences are well understood.

As used herein, a “reduced power consumption state” may be defined as an operational mode where the UE does not consume as much power as when operating in a normal power consumption state. In a reduce power consumption state, various portions of the UE may be deactivated, such as, for example the primary radio (e.g., transceiver) used for communicating over the main wireless channel, central processing units (CPUs), digital signal processing units (DSPs), and/or portions thereof. However, some portions of the UE may remain active, such as, for example, the side channel receiver, low power processors, portions of the transceiver, and/or portions of CPUs and/or DSPs.

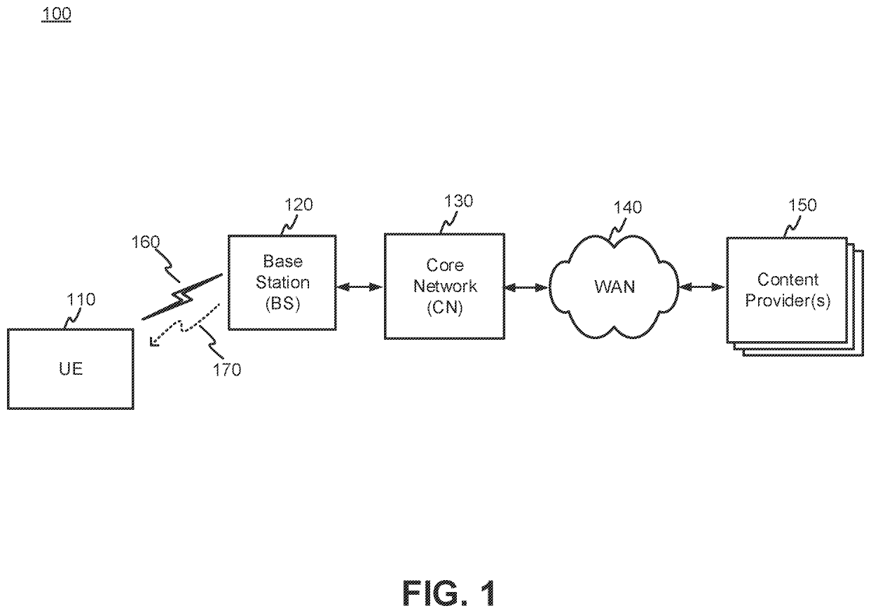

FIG. 1 is a diagram illustrating an example wireless communication system 100 consistent with an embodiment. As shown in FIG. 1, environment 100 may include a user equipment device (UE) 110, a base station (BS) 120, a core network (CN) 130, and content providers 140. For ease of explanation, only one UE 110, BS 120, and CN 130 is shown, however, in practice, wireless communication system 100 would have a plurality of such devices. UE 110 may communicate with BS 120 over main wireless channel 160 to exchange data and/or control signals using any type of known cellular technology, such as, for example, LTE, LTE Advanced, 5G, etc. Additionally, UE 110 may receive flow control signals from BS 120 via side channel 170. BS 120 transmits the flow control signals to each UE 110 under control of BS 120, and may include one or more unique identifiers associated with UE 110 (e.g., international mobile equipment identity (IMEI)). The flow control signals may be encoded using any modulation scheme (e.g., BPSK) and/or flow control sequences (e.g., Zadoff-Chu sequences).

Main wireless channel 160 may be used to exchange data with CN 130 via BS 120 through one or more dedicated channels having varying levels of priority. CN 130 may further exchange data with content provider(s) 150 via WAN 140, which may further include a backhaul network (not shown). Accordingly, through BS 120 and CN 130, UE 110 may obtain access to content provider(s) 150 supporting, for example, internet protocol (IP) multimedia subsystem (IMS) for exchanging IP data using any application protocol, such as session initiation protocol (SIP). Side channel 170 may be a wireless narrowband (e.g., a single 15 kHz subchannel) low power signal which uses a low-level modulation scheme. Examples of such signals may be utilized for conventional pilot signals, paging signals, and/or Internet of things (IoT) device signals.

UE 110 may be in various states of connection with BS 120 via main wireless channel 160. For example, some UE 110 may have radio connections in an active state (e.g., radio resource connection (RRC) active) where data may be exchanged. Alternatively, when in a reduced power consumption state, UE 110 may have idle radio connections (e.g., RRC idle).

Further referring to FIG. 1, UE 110 may include any device with long-range (e.g., cellular or mobile wireless network) wireless communication functionality. For example, UEs 110 may include a handheld wireless communication device (e.g., a mobile phone, a smart phone, a tablet device, etc.); a wearable computer device (e.g., a head-mounted display computer device, a head-mounted camera device, a wristwatch computer device, etc.); a laptop computer, a tablet computer, or another type of portable computer; a desktop computer, or a digital media player (e.g., Apple TV®, Google Chromecast®, Amazon Fire TV®, etc.); a smart television; a portable gaming system; a global positioning system (GPS) device; a home appliance device; a home monitoring device; and/or any other type of computer device with wireless communication capabilities and a user interface. UE 110 may also include any type of customer premises equipment (CPE) such as a set top box, a wireless hotspot (e.g., an LTE or 5G wireless hotspot), a femto-cell, etc. UE 110 may include capabilities for voice communication, mobile broadband services (e.g., video streaming, real-time gaming, premium Internet access etc.), best effort data traffic, and/or other types of applications.

In some implementations, UEs 110 may communicate using machine-to-machine (M2M) communication, such as machine-type communication (MTC), a type of M2M communication and/or another type of M2M communication. UE 110 may be embodied as an IoT device, which may include health monitoring devices, asset tracking devices (e.g., a system monitoring the geographic location of a fleet of vehicles, etc.), sensors (e.g., utility sensors, traffic monitors, etc.).

BS 120 and CN 130 provide access to content providers 150 for providing multimedia IP services to UE 110 via WAN 140. Such services may include mobile voice service (e.g., various forms of voice over Internet Protocol (VoIP)), short message service (SMS), multimedia message service (MMS), multimedia broadcast multicast service (MBMS), Internet access, cloud computing, and/or other types of data services.

In some implementations, BS 120 and CN 130 may include Long Term Evolution (LTE) and/or LTE Advanced (LTE-A) capability, where BS 120 may include an eNodeB, and CN 130 may include an evolved packet core (EPC) network. Alternatively, in other implementations, BS 120 and CN 130 may include 5G access capability, where BS 120 may include a next generation Node B (gNodeB), and CN 130 may serve as a 5G packet core (5GC) network. Such implementations may include functionalities such as 5G new radio (NR) base stations; carrier aggregation; advanced or massive multiple-input and multiple-output (MIMO) configurations; Heterogeneous Networks (HetNets) of overlapping small cells and macrocells; Self-Organizing Network (SON) functionality; MTC functionality, such as 1.4 MHz wide enhanced MTC (eMTC) channels (also referred to as category Cat-M1), Low Power Wide Area (LPWA) functionality such as Narrow Band (NB) IoT (NB-IoT) functionality, and/or other types of MTC functionality.

Content providers(s) 150 may include one or more devices, such as computer devices, databases, and/or server devices, that facilitate IP data delivery services. Such services may include supporting IoT applications such as alarms, sensors, medical devices, metering devices, smart home devices, wearable devices, retail devices, etc. Other services may include supporting other communications applications (e.g., SMS, etc.), automotive applications, aviation applications, etc. Content provider(s) 150 may communicate with UEs 110 over BS 120 and CN 130 using IP and/or non-IP bearer channels.

Although FIG. 1 shows example components of wireless communication system 100, in other implementations, wireless communication system 100 may include fewer components, different components, differently arranged components, or additional components than depicted in FIG. 1. Additionally, or alternatively, one or more components of wireless communication system 100 may perform functions described as being performed by one or more other components of wireless communication system 100.

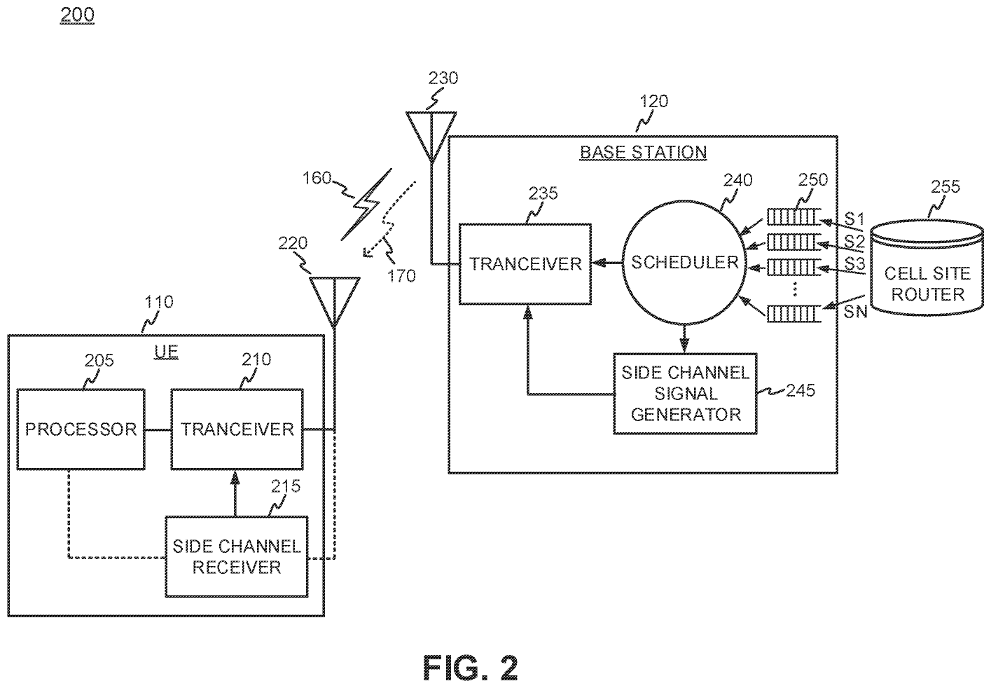

FIG. 2 is a block diagram 200 showing an example configuration for components of UE 110 and a BS 120 consistent with an embodiment. As shown in FIG. 2, UE 110 may include a processor 205, a transceiver 210, a side channel receiver 215, and an antenna 220. BS 120 may include a transceiver 235, a scheduler 240, a side channel signal generator 245, and packet queue buffers 250.

BS 120 may receive from cell site router 255, data flows organized into different sessions: Session 1, . . . , Session N (S1, . . . , SN). The sessions may be separate data flows from distinct users, and/or different application data flows corresponding to the same user. Upon being received, the data flows from the sessions S1, . . . , SN may be buffered into packet queue buffers 250. In a conventional system, scheduler 240 may receive sessions S1, . . . , SN and buffer each session until radio access network resources (e.g., physical resource blocks) are available, and the cycle of a cDRX interval for UE 110 has arrived.

However, in an embodiment, rather than waiting for a cDRX interval, scheduler 240 may send a message to side channel signal generator 245 to generate a side channel signal using a flow control sequence based on a unique identifier associated with UE 110. For example, side channel signal generator 245 may modulate an IMEI of UE 110 with a numerical code, such as, for example, a Zadoff-Chu sequence. Scheduler 240 may then send scheduled packets from the appropriate data flows to transceiver 235, where they be transmitted over main wireless channel 160 via antenna 230. In an embodiment, the data flows may be transmitted in the form of physical resource blocks (PRBs). Transceiver 235 may also receive the flow control sequence from side channel signal generator 245, and transmit the side channel signal over side channel 170 via antenna 230 using PRBs. In an embodiment, the transmission of the scheduled packets and the side channel signal may occur substantially simultaneously over main wireless channel 160 and side channel 170, respectively.

UE 110 may be in a reduced power consumption state where various components may be unpowered, such as, for example, at least parts of transceiver 210 and/or processor 205. However, side channel receiver 215 maintains power and is in an operational state even when UE 110 is in a reduced power consumption state. Upon receiving the side channel signal via antenna 220, side channel receiver 215 may demodulate/decode the flow control sequences from the side channel signal and provide a command that transitions transceiver 210 and/or processor 205 from the reduced power consumption state to a fully operational state. This transition occurs with sufficient time for transceiver 210 to receive the signal over main wireless channel 160 via antenna 220, and demodulate the signal to recover the data flows encoded therein. The data flows may be passed to processor 205, having been awaked by side channel receiver 215, for subsequent use in applications and/or an operating system residing within UE 110.

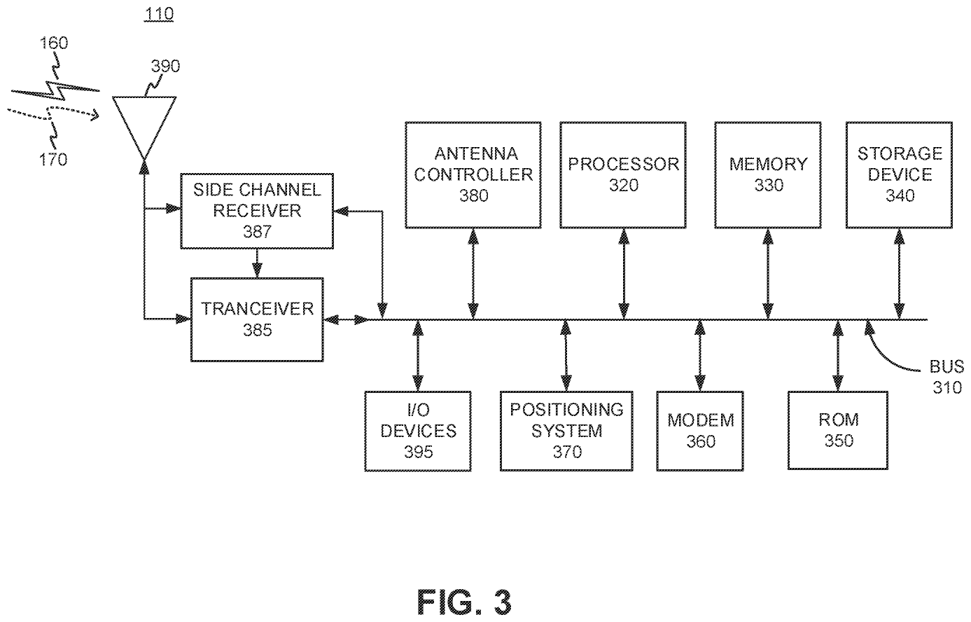

FIG. 3 a block diagram showing example components of UE 110 according to an embodiment. Referring to FIG. 3, UE 110 may include bus 310, processor 320, memory 330, storage device 340, ROM 350, modem 360, positioning system 370, antenna controller 380, transceiver 385, side channel receiver 387, antenna array 390, and I/O devices 395. Bus 310 may interconnect each of the components of UE 110 either directly or indirectly to exchange commands and/or data.

Processor 320 may include a processor, microprocessor, or processing logic that may interpret and execute instructions. Memory 330 may include a random-access memory (RAM) or another type of dynamic storage device that may store information and instructions for execution by processor 320. Storage device 340 may include a persistent solid state read/write device, a magnetic, and/or optical recording medium and its corresponding drive. ROM 350 may include a ROM device or another type of static storage device that may store static information and instructions for use by processor 320.

Modem 360 may perform various communications and signal processing operations allowing for UE 110 to efficiently communicate over a network. Modem 360 may perform operations for data exchange via a 5G network, which may include, for example, signal conditioning (e.g., filtering), signal encoding and decoding (e.g., orthogonal frequency division multiplexing), signal modulation and demodulation (e.g., binary phase shift keying, quadrature amplitude modulation, etc.), and/or error correction for data being transferred over the access stratum. Modem 360 may also operate in the non-access stratum and thus facilitate signaling and coordination with network devices in wireless access network to manage the establishment of communication sessions and for maintaining continuous communications. Furthermore, in various embodiments, modem 360 may perform signal processing operations in conjunction with side channel receiver 387 depending upon the power consumption of modem 360. For example, modem 360 may perform correlation operations of the flow control sequences received over side channel 170, and or detecting the angles of the resulting correlation operations.

Positioning system 370 may include a variety of receivers, sensors, and/or processors to provide relative and/or absolute position and orientation data of UE 110. For example, positioning system 370 may include a satellite navigation system, such as, for example, global positioning system (GPS) component, which may provide position information in relation to a standard reference frame. In another embodiment, positioning system may include an internal measurement unit (IMU) to determine relative displacements based on measured accelerations, and/or gyroscopes to measure angular displacements such as the roll, pitch, and yaw of the mobile device. Positioning system 370 may further include sensors, such as magnetometers, which may be used to determine orientation in a reference frame, such as, for example, the angular orientations with respect to magnetic and/or true north.

Antenna controller 380 may accept data for transmission from processor 320 and/or modem 360, and perform TX MIMO encoding to produce multiple channels of data for a set of the antenna elements (not shown) in antenna array 390, which may be transmitted over an uplink via main wireless channel 160. Signals received via main wireless channel 160 on a downlink through antenna array 390 may be decoded using RX MIMO decoding to combine streams into fewer data channels or a single received channel. Antenna controller 380 may further apply beamforming weights (which perform relative phase, frequency, and amplitude modulations between the antenna elements) on the transmit data streams to electronically adjust the transmit antenna pattern. Additionally, antenna controller 380 may apply beamforming weight to the receive data streams to electronically adjust the receive antenna pattern. Such adjustments may include main lobe pointing (the antenna pattern's main lobe may also be referred to herein as the “antenna beam,” the “beam,” or the “main beam”). Other adjustments may include “forming nulls” which may include pointing side lobe nulls in a particular direction and/or changing the side lobe pattern to alter the placement and/or depth of antenna pattern nulls.

Transceiver 385 may include discreet RF elements to amplify, frequency demodulate (e.g., down convert) analog channels received over antenna array 390 and convert the analog channels to received digital streams using analog to digital converters. The received digital streams may be passed to antenna controller 380 which may further perform RX MIMO processing to combine MIMO streams. Transceiver 385 may further process transmit digital streams, which may be TX MIMO encoded by antenna controller 380 prior to being converted to analog signals using digital to analog converters. The analog signals may be frequency upconverted and amplified for transmission by Transceiver 385, and subsequently radiated by antenna array 390 over main wireless channel 160.

Side channel receiver 387 may receive a side channel signal having a flow control sequences encoded therein. Side channel receiver 387 may be separate or included within transceiver 385. In an embodiment, side channel receiver 387 may be implemented in hardware for high speed operation and/or low power consumption. Upon receiving a flow control sequence over side channel 170, side channel receiver 387 may provide a command signal directly to transceiver 385 to transition to an operation mode in order to receive data flows carried by PRBs over main wireless channel 160. In an alternative embodiment, side channel receiver signal processor 320 to indirectly issue the command to wake transceiver 385. The side channel signal may be a low power signal that is transmitted by BS 120 over a sub band having a lower bandwidth (e.g., 15 kHz). The side channel signal may be similar in power to pilot signals used in wireless communication systems. The flow control sequences provided over side channel 170 may be selected for their ease of demodulation and robustness to noise.

Antenna array 390 may include at least two antenna elements (shown in FIG. 3 as a single antenna) which have independent channels that may be used for electronic adjustments of both the transmit and receive antenna patterns, and/or also for transmit and/or receive MIMO processing to improve wireless channel reliability and/or throughput.

I/O devices 395 may include one or more mechanisms that permit an operator to input information to UE 110, such as, for example, a keypad or a keyboard, a microphone, voice recognition and/or biometric mechanisms, etc. I/O devices 395 may also include one or more mechanisms that output information to the operator, including a display, a speaker, etc.

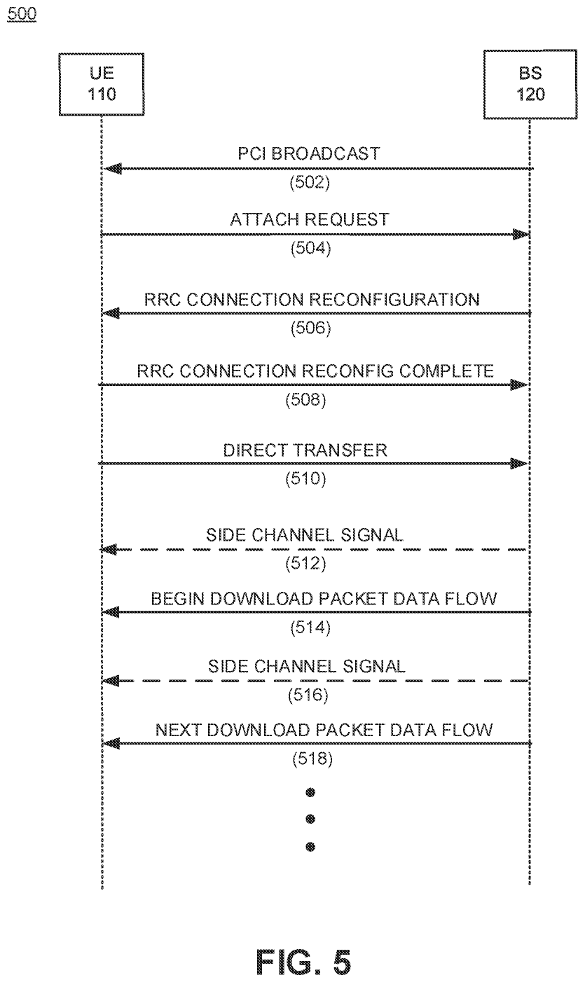

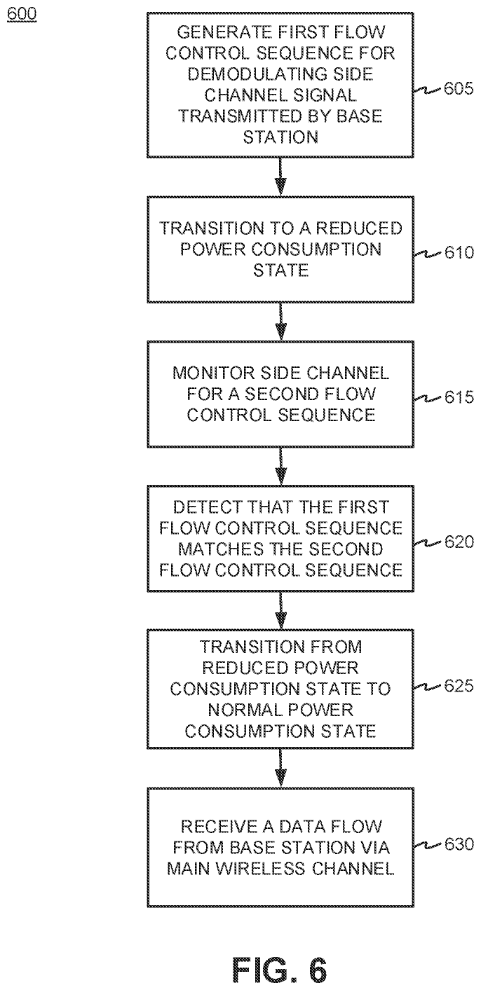

UE 110 may perform certain operations or processes, as may be described in detail below. UE 110 may perform these operations in response to processor 320 executing software instructions contained in a computer-readable medium, such as memory 330. A computer-readable medium may be defined as a physical or logical memory device. A logical memory device may include memory space within a single physical memory device or spread across multiple physical memory devices. The software instructions may be read into memory 330 from another computer-readable medium, such as storage device 340, or from another device via the network. The software instructions contained in memory 340 may cause processor 320 to exchange messages and/or perform operations or processes, in total or in-part, as described in FIGS. 5 and 6, respectively. Alternatively, hardwired circuitry may be used in place of or in combination with software instructions to implement processes consistent with the principles of the embodiments. Thus, example implementations are not limited to any specific combination of hardware circuitry and software.

The configuration of components of UE 110 illustrated in FIG. 3 is for illustrative purposes only. It should be understood that other configurations may be implemented. Therefore, UE 110 may include additional, fewer and/or different components than those depicted in FIG. 3.

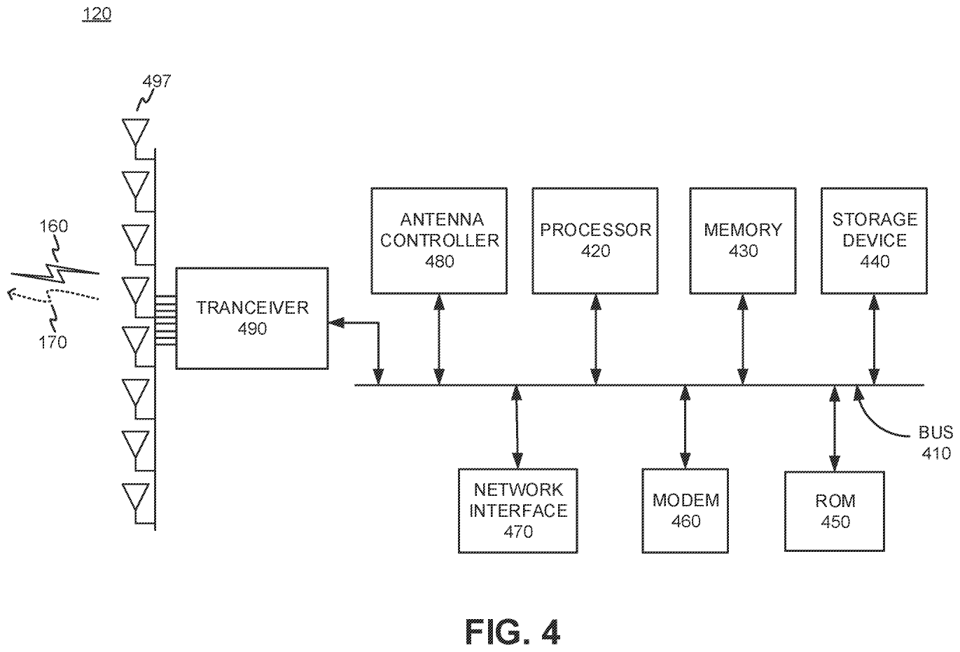

FIG. 4 is a block diagram showing example components of BS 120 according to an embodiment. BS 120 may provide wireless access to UE 110 using various wireless technologies, such as, for example, 5G, LTE, LTE Advanced, etc. BS 120 may further provide wireless and/or wireless network connectivity to other devices connected to evolved Packet Core (ePC) (through, for example, a backhaul network), and network devices connected to wide area networks (e.g., the Internet). BS 120 may include a processor 420, a memory 430, a storage device 440, a ROM 450, a modem 460, a network interface 470, transceiver 490, and an antenna array 497. The components of BS 120 may interface (either directly or indirectly) to a bus 410 to exchange data.

Processor 420 may include one or more processors, microprocessors, application specific integrated circuits (ASICs), field programmable gate arrays (FPGAs), and/or other processing logic that may interpret and execute instructions and/or low-level logic. Processor 420 may control operation of BS 120 and its components. In an embodiment, processor 420 may generate or assist in the generation of the flow control sequence, such as, for example, the Zadoff-Chu sequence, for transmission via side channel 170. Thus, processor 420 may perform, in whole or in part, the functionality of side channel signal generator 245. In an embodiment, additional functionality for generating the flow control sequence may be performed by modem 460 and/or transceiver 490. Moreover, processor 420 may perform the functionality of scheduler 240 in scheduling the packet data from sessions S1, . . . , SN that are received from cell site router 255.

Memory 430 may include a random access memory (RAM) or another type of dynamic storage device to store data and instructions that may be used by processor 420. In an embodiment memory 430 may be used to implement packet queue buffers 250 for storing packets from sessions S1, . . . , SN received by cell site router 255 as shown in FIG. 2.

Storage device 440 may include a persistent solid state read/write device, a magnetic, and/or optical recording medium and its corresponding drive. ROM 450 may include a ROM device or another type of static storage device that may store static information and instructions for use by processor 420.

Modem 460 may perform various communications and signal processing operations allowing for BS 120 to efficiently communicate over the wireless network. Modem 460 may also perform processing to facilitate communications over the back-haul network. Modem 460 may perform signal conditioning (e.g., filtering), signal encoding and decoding (e.g., OFDMA), signal modulation and demodulation (e.g., BPSK, M-PSK, M-QAM, etc.), and/or error correction for data being transferred over the access stratum. Modem 460 may also operate in the non-access stratum and thus facilitate signaling and coordination with network devices in wireless access network to manage the establishment of communication sessions and for maintaining continuous communications. In an embodiment, modem 460 may perform side channel signaling, such as, for example, by generating or assisting in the generation of the flow control sequence (e.g., the Zadoff-Chu sequence) for transmission via side channel 170. Thus, modem 406 may perform, in whole or in part, the functionality of side channel signal generator 245. Modem 406 may work in conjunction with processor 420 in generating the flow control sequences and/or side channel signal. In general, modem 460 and processor 420 may function together facilitate the operations of BS 120 in accordance with a variety of wireless and/or wired communication protocols.

Network interface 470 may include a logical component that includes input and/or output ports, input and/or output systems, and/or other input and output components that facilitate the transmission of data to other devices via the backhaul network. Network interface 470 may include a standard interface cards for wired communications with cell site router 255 and/or a wireless network interfaces for wireless communications and/or microwave interfaces for communications with other base stations and/or the backhaul network. Such communication standards may include, for example, local area network(s) (LAN) (e.g., WiFi), wireless wide area networks (WAN), and/or one or more wireless public land mobile networks (PLMNs). The PLMN(s) may include 5G systems, which may operate at higher frequencies, such as, for example, about 28 GHz, a Global System for Mobile Communications (GSM) PLMN, a Long Term Evolution (LTE) PLMN, and Advanced LTE PLMN, and/or other types of PLMNs not specifically described herein. A back-end network may exchange data with the wireless access network(s) to provide access to various content providers 150, servers and gateways (not shown), etc. The back-end network may include WAN 140, a metropolitan area network (MAN), an intranet, the Internet, a wireless satellite network, a cable network (e.g., an optical cable network), etc.

Antenna controller 480 may accept data and/or commands (e.g., pointing/beamforming commands) from processor 420 and/or modem 460. Antenna controller 480 may perform TX MIMO encoding to produce multiple channels of data, for a set of the antenna elements in antenna array 497, which may be transmitted over main wireless channel 160. Moreover, antenna controller 480 may perform encoding to produce subchannels which may include a downlink for transmitting side channel 170.

Signals which have been received over an uplink channel from mobile device 110 via antenna array 497 may be decoded using RX MIMO decoding to combine streams into fewer data channels or a single received channel. Antenna controller 480 may further apply beamforming weights (which perform relative phase, frequency, and amplitude modulations between the antenna elements) on the transmit data streams to electronically adjust the transmit antenna pattern. Additionally, antenna controller 480 apply beamforming weights on the receive data streams to electronically adjust the receive antenna pattern. Such adjustments may include main lobe pointing. Other adjustments may include “forming nulls.” Forming nulls may include pointing side lobe nulls in a particular direction and/or changing the side lobe pattern to alter the placement and/or depth of antenna pattern nulls. In various embodiments, the beamforming weights may be incorporated into a precoding matrix that may be used for other processing, such as, for example, MIMO processing.

Transceiver 490 may include discreet RF elements to amplify, frequency demodulate (e.g., down convert) analog channels received via an uplink over main wireless channel 160 through antenna array 497, and convert the analog channels to received digital streams using analog to digital converters. The received digital streams may be passed to antenna controller 480 which may further perform RX MIMO processing to combine MIMO streams. Transceiver 490 may further process transmit digital streams, which may be TX MIMO encoded by antenna controller 480 prior to being converted to analog signals using digital to analog converters. The analog signals may be frequency upconverted and amplified for transmission by transceiver 490, and subsequently radiated by antenna array 497 via a downlink over main wireless channel 160. Transceiver 490 may further receive flow control sequence(s) from processor 420 and/or modem 460 for transmission over side channel 170.

Antenna array 497 may include a plurality of antenna elements in order to serve multiple sectors and/or to provide various antenna characteristics (e.g., antenna beam width, gain, side lobe control, etc.) appropriate for operations of BS 120.

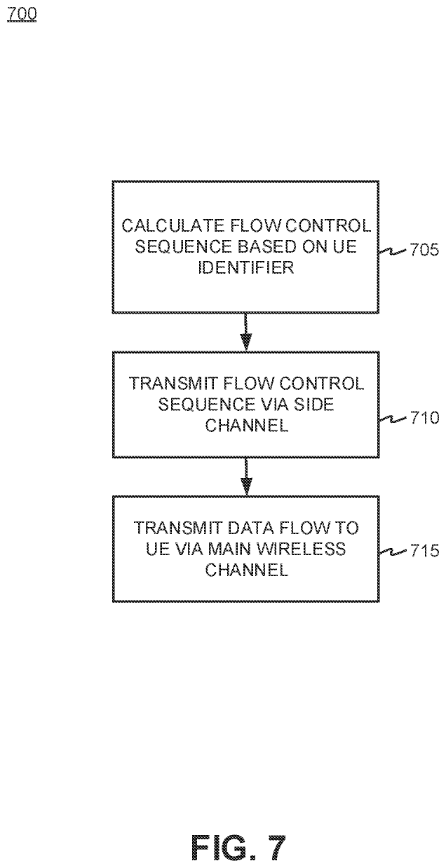

As described herein, BS 120 may perform certain operations in response to processor 420 and/or modem 460 executing software instructions contained in a computer-readable medium, such as memory 430, ROM 450, and/or storage device 440. A computer-readable medium may be defined as a non-transitory memory device. A non-transitory memory device may include memory space within a single physical memory device or spread across multiple physical memory devices. The software instructions may be read into memory 430 from another computer-readable medium or from another device via network interface 470. The software instructions contained in memory 430 may cause processor 420 to exchange messages and/or perform operations or processes, in total or in-part, as described in FIGS. 5 and 7, respectively. Alternatively, hardwired circuitry may be used in place of, or in combination with, software instructions to implement processes described herein. Thus, implementations described herein are not limited to any specific combination of hardware circuitry and software.

Although FIG. 4 shows example components of BS 120, in other implementations, BS 120 may include fewer components, different components, differently arranged components, or additional components than those depicted in FIG. 4. Additionally or alternatively, one or more components of BS 120 may perform the tasks described as being performed by one or more other components of BS 120.

FIG. 5 is a diagram 500 showing example message flows between UE 110 and BS 120. The message flow diagrams show network components which may correspond to LTE and/or 5G network devices or components. That is, for example, BS 120 may be an “eNodeB” and/or a “gNodeB.”

Flow diagram 500 initially shows BS 120 sending a physical cell identification (PCI) broadcast to UE 110 (502). The PCI broadcast identifies a physical cell for download synchronization, which may include a primary synchronization signal. In an embodiment, UE 110 may also receive a root sequence for a flow control sequence (e.g., Zadoff-Chu) from BS 120 in message 502. In an embodiment, a root sequence may be a Zadoff-Chu sequence that has not been shifted. In response, UE 110 may respond to BS 120 by sending an attach request message (504). At this point, the radio resource control (RRC) connection initiation is complete, and the attach procedure may be initiated. In response, BS 120 may send to the UE an RRC connection reconfiguration message (506). Message 506 may initiate an RRC connection reconfiguration procedure to establish, modify, and/or release radio bearers and/or activate a default radio bearer. Once reconfigured, UE 110 may send an RRC connection reconfiguration complete message (508) to BS 120 in response to the RRC connection reconfiguration message 506. UE 110 may then send to BS 120 a direct transfer message (510), which may provide an attach complete notification that includes bearer identifier, network access stratum (NAS) sequence number, etc. During the attach procedure, BS 120 may receive a unique identifier associated with UE 110 (e.g., IMEI) which may be used to generate a flow control sequence specifically for UE 110. After UE 110 completes an attachment and registration procedure, UE 110 may both enter an RCC Idle state, which can include entering a reduced power consumption state, until BS 120 has data packets (e.g., in the form of packet resource blocks) available.

Further referring to FIG. 5, BS 120 may send side channel signal to UE 110 for transitioning UE 110 from a reduced power consumption state to an operational state for receiving packet data. Once UE 110 receives and identifies that side channel signal has an identifier associated with UE 110 encoded therein (e.g., the IMEI), UE 110 may transition from the reduced power consumption state to an operational state to receive the data flows over the main wireless channel 160. If enough time passes where UE 110 transitions again to a reduced power consumption state, BS 120 may send a side channel signal again (516) to “wake” UE 110 for receiving a subsequent download data flow (518) from UE 120. The pattern of the side channel signal proceeding subsequent download data flows may continue as long as UE 110 is connected to BS 120.

FIG. 6 shows a flow chart of an example process 600 for controlling data flows with a side channel. In an embodiment, process 600 may be performed by UE 110 using, for example, processor 320, modem 360, and/or side channel receiver 387.

Initially, UE 110 may generate a first flow control sequence for demodulating side channel 170 signal transmitted by BS 120 (Block 605). UE 110 may receive an initial sequence from BS 120 via main wireless channel 160 to facilitate the generation of the first flow control sequence. In an embodiment, the initial sequence may be a root sequence. UE 110 may determine the first flow control sequence based upon the initial sequence and an identifier associated with UE 110. For example, UE 110 may generate the first flow control sequence by calculating a Zadoff-Chu sequence based upon the international mobile equipment identity (IMEI) value associated with the UE.

UE 110 may then transition to a first power consumptions state, such as, for example, a reduced power consumption state as shown in FIG. 6 (Block 610). In the reduced power consumption state, portions of UE 110, such as transceiver 385, may be deactivated or placed in an idle mode to reduce current draw from the internal power source (e.g., battery) of UE 110. However, portions of UE, such as, for example, side channel receiver 215 do not enter the reduced power consumption state in order to receive flow control sequences over side channel 170.

UE 110 may then monitor, while in the reduced power consumption state, side channel 170 for a second flow control sequence (Block 615). In an embodiment, monitoring by UE 110 may include receiving a wireless signal via side channel 170 transmitted by BS 120 and demodulating the wireless signal received via main wireless channel 160 to recover the second flow control sequence. Additionally, UE 110 may determine an angle of correlation between the first flow control sequence and the second control sequence.

UE 110 may identify that the first flow control sequence matches the second flow control sequence (Block 620). In an embodiment, UE may detect a match between the first flow control sequence and the second flow control sequence by detecting a peak in an angle of the correlation between the first flow control sequence and the second flow control sequence.

Upon detecting that the first flow control sequence matches the second flow control sequence, UE 110 may transition from the reduced power consumption state to a second power consumption state, such as, for example, a normal power consumption state as shown in FIG. 6 (Block 625). UE 100 may receive a data flow from BS 120 via main wireless channel 160 (Block 630).

FIG. 7 illustrates a flow chart of an example process 700 for controlling data flows with a side control channel. In an embodiment, process 700 may be performed by BS 120 using, for example, processor 420, modem 460, antenna controller 480 and/or side channel signal generator 245. BS may initially calculate a flow control sequence based on an identifier associated with UE 110 (Block 705). In an embodiment, the identifier may include the IMEI of UE 110. BS 120 may then transmit the flow control sequence over side channel 170 to UE 110 (Block 710). BS 120 may then transmit data flow to UE 110 via main wireless channel 160 (Block 715).

The foregoing description of implementations provides illustration and description, but is not intended to be exhaustive or to limit the invention to the precise form disclosed. Modifications and variations are possible in light of the above teachings or may be acquired from practice of the invention. For example, while series of blocks have been described with regard to FIGS. 6 and 7, and message flows with regard to FIG. 5, the order of the blocks and messages may be modified in other embodiments. Further, non-dependent messaging and/or processing blocks may be performed in parallel.

Certain features described above may be implemented as “logic” or a “unit” that performs one or more functions. This logic or unit may include hardware, such as one or more processors, microprocessors, application specific integrated circuits, or field programmable gate arrays, software, or a combination of hardware and software.

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

To the extent the aforementioned implementations collect, store, or employ personal information of individuals, groups or other entities, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various access control, encryption and anonymization techniques for particularly sensitive information.

The terms “comprises” and/or “comprising,” as used herein specify the presence of stated features, integers, steps or components but does not preclude the presence or addition of one or more other features, integers, steps, components, or groups thereof. Further, the term “example” (e.g., “example embodiment,” “example configuration,” etc.) means “as an example” and does not mean “preferred,” “best,” or likewise.

No element, act, or instruction used in the description of the present application should be construed as critical or essential to the invention unless explicitly described as such. Also, as used herein, the article “a” is intended to include one or more items. Further, the phrase “based on” is intended to mean “based, at least in part, on” unless explicitly stated otherwise.

What is claimed is:

1. A method, comprising:
generating, at a user equipment device (UE), a first flow control sequence for demodulating a first wireless channel transmitted by a base station;
transitioning, by the UE, to a reduced power consumption state;
monitoring, by the UE while in the reduced power consumption state, the first wireless channel for a second flow control sequence;
detecting, at the UE, that the first flow control sequence matches the second flow control sequence;
transitioning, by the UE from the first power consumption state to a second power consumption state, upon detecting that the first flow control sequence matches the second flow control sequence; and
receiving, at the UE, a data flow from the base station via a second wireless channel.

2. The method of claim 1, further comprising:
receiving, at the UE, an initial sequence from the base station via the second wireless channel, wherein the initial sequence is a root sequence.

3. The method of claim 2, wherein the generating a first flow control sequence comprises:
determining the first flow control sequence based upon the initial sequence and an identifier associated with the UE.

4. The method of claim 3, wherein determining the first flow control sequences comprises:
calculating a Zadoff-Chu sequence based upon the international mobile equipment identity (IMEI) value associated with the UE.

5. The method of claim 1, wherein the monitoring the first wireless channel for the second flow control sequence further comprises:
receiving a wireless signal via the first wireless channel transmitted by the base station;
demodulating, by the UE, the wireless signal received via the first wireless channel to recover the second flow control sequence; and
determining an angle of correlation between the first flow control sequence and the second control sequence.

6. The method of claim 5, wherein the detecting at the UE that the first flow control sequence matches the second flow control sequence comprises:
detecting a peak in an angle of the correlation between the first flow control sequence and the second flow control sequence.

7. The method of claim 1, wherein the first wireless channel comprises a side channel, and the second wireless channel comprises a main wireless channel having a greater bandwidth than the side channel.

8. A user equipment device (UE), comprising:
a transceiver;
a side channel receiver; and
a processor coupled to the transceiver and side channel receiver, wherein the processor is configured to:
generate a first flow control sequence for demodulating a first wireless channel transmitted by a base station;
transition to a first power consumption state;
monitor the first wireless channel for a second flow control sequence;
detect that the first flow control sequence matches the second flow control sequence;
transition from the first power consumption state to a second power consumption state, upon detecting that the first flow control sequence matches the second flow control sequence; and
receive a data flow from the base station by the transceiver via a second wireless channel.

9. The UE of claim 8, wherein the processor is further configured to:
receive, by the side channel receiver, an initial sequence from the base station via the second wireless channel, wherein the initial sequence is a root sequence.

10. The UE of claim 9, wherein upon generating a first flow control sequence, the processor is configured to:
determine the first flow control sequence based upon the initial sequence and an identifier associated with the UE.

11. The UE of claim 10, wherein upon determining the first flow control sequences, the processor is configured to:
calculate a Zadoff-Chu sequence based upon the international mobile equipment identity (IMEI) value associated with the UE.

12. The UE of claim 8, wherein upon monitoring the first wireless channel for the second flow control sequence, the processor is further configured to:
receive a wireless signal via the second wireless channel transmitted by the base station;
demodulate the wireless signal received via the second wireless channel to recover the second flow control sequence; and
determine an angle of correlation between the first flow control sequence and the second control sequence.

13. The UE of claim 12, wherein upon detecting that the first flow control sequence matches the second flow control sequence, the processor is further configured to:
detect a peak in an angle of the correlation between the first flow control sequence and the second flow control sequence.

14. The UE of claim 8, wherein the first wireless channel comprises a side channel, and the second wireless channel comprises a main wireless channel having a greater bandwidth than the side channel.

15. A non-transitory computer-readable medium comprising instructions, which, when executed by a processor, cause the processor to:
generate a first flow control sequence for demodulating a first wireless channel transmitted by a base station;
transition to a first power consumption state;
monitor the first wireless channel for a second flow control sequence;
detect that the first flow control sequence matches the second flow control sequence;
transition from the first power consumption state to a second power consumption state, upon detecting that the first flow control sequence matches the second flow control sequence; and
receive a data flow from the base station by the transceiver via a second wireless channel.

16. The non-transitory computer-readable medium of claim 15, wherein the instructions further cause the processor to:
receive, by the side channel receiver, an initial sequence from the base station via the second wireless channel, wherein the initial sequence is a root sequence.

17. The non-transitory computer-readable medium of claim 16, wherein the instructions for generating a first flow control further cause the processor to:
determine the first flow control sequence based upon the initial sequence and an identifier associated with the UE.

18. The non-transitory computer-readable medium of claim 17, wherein the instructions for determining the first flow control sequence further cause the processor to:
calculate a Zadoff-Chu sequence based upon the international mobile equipment identity (IMEI) value associated with the UE.

19. The non-transitory computer-readable medium of claim 15, wherein the instructions for monitoring the first wireless channel for the second flow control sequence, the instructions further cause the processor to:
receive a wireless signal via the second wireless channel transmitted by the base station;
demodulate the wireless signal received via the second wireless channel to recover the second flow control sequence; and
determine an angle of correlation between the first flow control sequence and the second control sequence.

20. The non-transitory computer-readable medium of claim 19, wherein the instructions for detecting that the first flow control sequence matches the second flow control sequence, further cause the processor to:
detect a peak in an angle of the correlation between the first flow control sequence and the second flow control sequence.
